(19) United States
(12) Patent Application Publication
(10) Pub. No.: US 2026/0018627 A1
(43) Pub. Date: Jan. 15, 2026

(54) PROTON EXCHANGE MEMBRANE FUEL CELLS BIPOLAR PLATE ASSEMBLY

(71) Applicant: ZEROAVIA LTD., Cirencester (GB)

(72) Inventors: John Anthony VOGEL, Charlton, NY (US); Rhonda STAUDT, Niskayuna, NY (US); Rudolf Jacobus COERTZE, Cirencester (GB)

(73) Assignee: ZEROAVIA LTD., Cirencester (GB)

(21) Appl. No.: 19/262,772

(22) Filed: Jul. 8, 2025

(30) Foreign Application Priority Data
Jul. 9, 2024 (GB) 2409971.5

(51) Int. Cl. H01M 8/0267; B64C 29/00; B64D 27/355; H01M 8/0297; H01M 8/10; H01M 8/1006

(52) U.S. Cl. CPC H01M 8/0267; B64D 27/355; H01M 8/0297; H01M 8/1006; B64C 29/00; H01M 2008/1095; H01M 2250/20

(57) ABSTRACT

A proton exchange membrane fuel cell bipolar plate (PEM FC BPP) assembly is provided. The PEM FC BPP assembly includes a cathode plate, an anode plate, and an insert. The insert is positioned between the cathode plate, an anode plate; and is comprised of a metal, a composite, a foil, a mesh, or a combination thereof, the insert includes at least one corrugated structure having peaks provided from 1-10 mm apart. The at least one corrugated structure is bonded to the anode and cathode plates at, at least one of its peaks and troughs. The disclosure also includes an electric device which includes the PEM FC BPP with cooling insert and where the electric device includes an electric vertical take-off and landing (eVTOL) aircraft.

### BACKGROUND

Recent developments in corrosion resistant aluminum plate coatings make lightweight, stamped bipolar plates for proton exchange membrane fuel cells (PEM FCs) a paradigm changing technology enabler for PEM in transportation applications. Stamped bipolar plates are highly thermally and electrically conductive, allowing for unprecedented power density operation and fluid cooling. A typical Bipolar Plate (BPP) has both stamped cooling and stamped reactant channels.

Some methods of aluminum bipolar plate manufacture involve stamping a cathode flow field on one side of a first plate while simultaneously forming the features for fluid cooling and metal bonding on the other side. Similarly, a second plate is stamped with fluid cooling and bonding features on one side while simultaneously forming an anode flow field on the other side. The two plates are then bonded, typically using braising or welding techniques, on the two, matching fluid cooling and bonding halves forming a bipolar plate assembly with cathode on one side, anode on the other and cooling in the middle. The plate assembly is then coated in the anode and cathode flow field areas.

However, such methods face a number of problems. For example, stamping complex flow field features, sealing features, bonding features and fluid-cooling features simultaneously on the same plate has proven to be very difficult if not impossible. Even with advanced modelling and testing, the result has been a suboptimized product.

Further, there is insufficient strength in the plate to hold load and maintain features during compression, especially in areas that transmit load, such as gasket grooves. This problem gets worse as the plate increases in size to address ever larger applications.

It is also exceedingly difficult to manufacture and hold tolerances which results in e.g., skewing, misalignment, lack of flatness, and over application of braising material or welding in the final assembly.

Moreover, there is a limited ability to control temperature across the width of the plate, resulting in unacceptable differences in temperature in the membrane electrode assembly (MEA).

For all the reasons above, there is a great desire for an improved PEM bipolar plate assembly which at least addresses the above well-known issues in the art.

### SUMMARY OF THE INVENTION

A fuel cell is an electrochemical cell that converts chemical energy into electrical energy by means of spontaneous electrochemical reduction-oxidation (redox) reactions. Fuel cells include an anode and a cathode separated by an ionically conductive electrolyte. Bipolar plates separate the reactant gases and distribute them on each side over the whole active area of the MEA. During operation, a fuel (e.g., hydrogen) is supplied to the anode and an oxidant (e.g., oxygen or air) is supplied to the cathode. The fuel is oxidized at the anode, producing positively charged ions (e.g., hydrogen ions) and electrons. The positively charged ions travel through the electrolyte from the anode to the cathode, while the electrons simultaneously travel from the anode to the cathode outside the cell via an external circuit, which produces an electric current. The oxidant supplied to the cathode is reduced by the electrons arriving from the external circuit and combines with the positively charged ions to form water.

The embodiments of the current application use an insert as a turbulator and stiffening feature to replace stamped cooling channels in a bipolar plate. The insert functions as a cooling flow field and separates the anode and cathode of different cells. In some embodiments, the insert is corrugated. The insert functions to decouple the forming of the anode, cathode and cooling flow fields while adding additional strength and structure by introducing at least one lightweight, aluminum corrugated foil or mesh to the assembly, creating a cooling flow field, metal bonding surface and stiffening feature to the bipolar plate.

The above insert, when compared against stamped cooling channels, promotes better heat transfer and stability/strength. The embodiments of the current application provide a more robust, corrosion resistant, fluid cooled, aluminum bipolar plate that also allows for PEM stacks to be developed and mass manufactured. Such advantages also offer an enhanced pathway to commercial success.

Furthermore, the embodiments of the current application offer an unexpected and surprising effect when compared to the embodiments from a combination of the knowledge in the prior art. For example, typical Bipolar Plates of the prior art remove material and attempt to optimize geometry rather than adding a layer and removing functions from the existing plates. The embodiments of the current application, for the first time, enable two monopolar plates with a lightweight, low-cost third layer that still achieves/improves cooling. This third layer has a structures herein collectively referred to as an insert. One skilled in the art with comprehensive knowledge of the prior art would find the achievement surprising and unexpected.

An optimized anode and cathode flow field plates that are designed with minimal weight, and with the required depth of reactant channels and gasket grooves. These structures are bonded together with an engineered ultralightweight, corrugated foil or mesh which is inserted between the two optimized anode and cathode flow field plates and bonded with a minimum of lightweight, low cost braising material.

The insert, for example, is a foil or mesh, which may be perforated, is folded or gathered in such a way as to provide several optimizations. For example, the distance between the plates is optimized to, for example, 1-10 mm or in some embodiments an optimized distance is from 3-5 mm. The pitch for cooling features is also optimized which in the context of PEM is, for example, 1-5 mm in thickness. Additionally, higher densities in load-bearing areas and the best bonding surfaces for heat transfer and the chosen manufacturing technique are also provided.

In embodiments which use a mesh structure, the mesh can be expanded or contracted and in embodiments which use perforations, they can be graduated in size and in varying pattern to increase or decrease cooling.

Perforations may optionally have scallops which can allow for better capture and redirection of cooling fluid flow to adjacent channels. These scallops may point in varying directions. For example, successive scallops in a line may point first to the left by 30° of that line and then to the right by 30° in a repeating pattern.

The foil or mesh designs promote turbulence in the cooling layer thereby improving the heat transfer characteristics and reducing required fan power. The plate's cooling may be divided into regimes of wider or narrower pitch and lower or higher densities of material in order to manage temperature distribution across the MEA. Additionally, the inserted foil or mesh may be multiple pieces, for example, brazed together like a patchwork quilt, which may have different geometry. The multiple pieces may be a number (e.g. 5) of different feature sizes. The mesh may be denser towards the portion of the plate which is hottest.

In some embodiments, an optimized cathode flow field plate may be derived with software e.g., CFD modeling, FEA modeling. The same techniques may be used to optimize the anode flow field plate and fluid-cooling layer. The fluid-cooling layer may be comprised of corrugated, stamped, folded or similarly formed aluminum plate or mesh to form an insert. In some embodiments, the insert is coated in braising material and braised together for assembly.

The density of the insert is managed over the surface of the insert by varying the pitch between the warp and weft wires where smaller pitch results in higher density, increased strength and higher stiffness. In some embodiments, this is used to create patterns, for example, twill and multiplex. Another method would be through a customized stamping of features (i.e. mesh, scallops or perforated metal) with tunable feature density (i.e. more or less perforations) enabled by a customized stamping tool with a convertible stamping head. For example, the strength, stiffness and cooling fluid turbulation characteristics of the insert are optimized by using a customized stamping tool instead of the brazed-together patchwork quilt to apply the previously described principles of smaller warp-weft pitch and cooling fluid turbulating characteristics by higher feature density in regions of higher temperature (i.e. plate edges). This can be tuned by appropriately sizing the “thickness” of the overall mesh—height between the bottom of a lower bend and the height of an upper bend—resulting in a strong, stiff reinforcing layer that would provide the optimal fluid gap between the two reactant plates for cooling. Additionally, the mesh would disrupt the thermal and velocity boundary layers of the incoming fluid resulting in much better heat removal from the system, following some similar principles as a heat radiator.

The specific materials used for manufacturing may vary. One suable material is aluminum. Other materials which are suitable for use in manufacture are, for example, stainless steel, performant alloys, or other high-strength-to-weight materials, for example, titanium.

Additive manufacturing may be used as an alternative to brazing. In some embodiments, all three layers, anode, insert, and cathode can all be additively manufactured in one integrated process.

The insert design may be optimized to fulfill the function of maintaining compression pressure between cells. For example, by optimizing the mechanical properties of the insert such that the insert may compress and decompress to provide and maintain optimal sealing pressure. For example, in some embodiments, the insert may have a greater degree of flexibility due to the foil/mesh structure resulting in more a greater ability to compress and decompress like e.g., a spring. An advantage of this embodiment is the elimination of the need for additional compression springs, saving weight and cost.

For applications in lower elevation electric vertical take-off and landing (eVTOL) aircraft, more gradation of features may be employed, e.g. via the brazed quilt-like approach or the continuous customized stamping tool approach, since cells in this kind of stack require the rapid removal of more heat compared to a high elevation large jet liner that is generally in the cruise stage and the flow field is less variable.

### DESCRIPTION OF POSSIBLE EMBODIMENTS

In some embodiments, a proton exchange membrane fuel cell bipolar plate (PEM FC BPP) assembly is provided. The PEM FC BPP assembly includes a cathode plate, an anode plate, and an insert. The insert is positioned between the cathode plate, an anode plate; and is comprised of a metal, a composite, a foil, a mesh, or a combination thereof, the insert includes at least one corrugated structure having peaks provided from 1-10 mm apart. The at least one corrugated structure is bonded to the anode and cathode plates at, at least one of its peaks and troughs.

In some embodiments, the at least one corrugated structure comprises at least one perforation.

In some embodiments, the at least one perforation is a scallop-shaped structure.

In some embodiments, the density of the perforations is greater toward an edge portion of the at least one corrugated structure than in a middle portion of the at least one corrugated structure.

In some embodiments, the insert comprises plurality pieces which are brazed together in a patchwork quilt configuration, where at least one piece of the insert has a different geometry than the other pieces of the insert.

In some embodiments, the insert is bonded to the cathode plate and the anode plate by brazing with metals or alloys of Au, Zn, Ni, or Cu.

In some embodiments, the at least one corrugated structure is comprised of warp and weft wires.

In some embodiments, the pitch between warp and weft wires is varied to form twill or multiplex patterns.

In some embodiments, the density of the warp and weft wires is greater toward an edge portion of the at least one corrugated structure than in a middle portion of the at least one corrugated structure.

In some embodiments, the use of gaskets to maintain pressure between fuel cells is replaced or minimized by the insert under compression.

In some embodiments, a method for cooling a proton exchange membrane fuel cell bipolar plate (PEM FC BPP) assembly is provided. The method includes passing a cooling fluid though an insert positioned between a cathode plate and an anode plate of the proton exchange membrane fuel cell bipolar plate. The insert is positioned between the cathode plate, an anode plate. The insert includes at least one corrugated structure having peaks provided from 1-10 mm apart. At least one corrugated structure is bonded to the anode and cathode plates at, at least one of its peaks and troughs.

In some embodiments, an electric device comprising an electric vertical take-off and landing (eVTOL) aircraft having the PEM FC BPP assembly is provided.

### BRIEF DESCRIPTION OF THE DRAWINGS

FIG. 1A illustrates a fuel cell.

FIG. 1B illustrates a stacked fuel cell.

FIG. 2 illustrates a perforated mesh.

FIG. 3 illustrates a scalloped perforated mesh.

FIG. 4 illustrates a corrugated perforated mesh.

FIG. 5 illustrates an alternative mesh design example.

FIG. 6 illustrates a wire mesh.

FIG. 7 illustrates an example of fluid and heat transfer across the MEA.

FIG. 8 illustrates an example of wire diameter and pitch variation.

FIG. 9 is a cross section in the direction of cooling fluid flow and illustrates an example of comparative prior art stamped cooling channels incorporated into the assembly.

FIG. 10 is a cross section view in the direction of cooling fluid flow and illustrates an example of a corrugated insert between the cathode BPP and anode BPP.

### DETAILED DESCRIPTION OF THE DRAWINGS

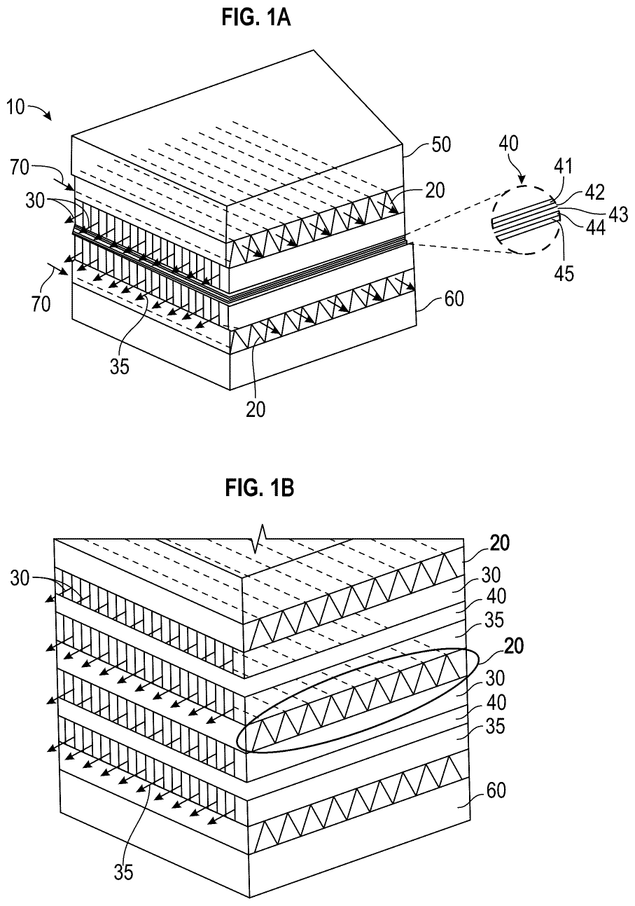

FIG. 1 shows a fuel cell (10) including a membrane electrode assembly (MEA) (40) and bipolar plate (BPP) including a cathode BPP (50) and an anode BPP (60) and also including cooling channels (20) which include a corrugated cooling insert provided in the cooling channels (20) and Cathode reactant channels (30) and anode reactant channels (35). Various embodiments of the corrugated cooling insert are provided in the figures and discussed further below. The dashed lines and arrows (70) indicate the direction of the coolant fluid flow through the cooling channels (20). The MEA (40) includes a first gasket (41) and a second gasket (45) as its outermost layers. Moving inwardly, a cathode gas diffusion electrode (GDE) (41) and anode GDE (44) is provided with a membrane positioned as the center layer.

Cathode reactant channels (30) and anode reactant channels (35) are provided between the MEA (40) and the respective cathode BPP (50) and an anode BPP (60). The arrows in the cathode reactant channels (30) and anode reactant channels (35) indicate the direction of the cathode reactant flow, e.g., a fluid e.g., oxygen and the direction of the anode reactant gas flow, e.g., hydrogen gas.

The fuel cell (10) of FIG. 1 constitutes a single cell.

FIG. 1B illustrates a stacked cell configuration. Multiple fuel cells (10) may be stacked on top of each other in repeating unites in a pattern comprising MEA (40), cathode reactant channels (30), cooling channels (20) comprised of an insert, anode reactant channels (35), and then restarting the pattern with another MEA (40). The pattern is bookended by cathode BPP (50) (not shown in FIG. 1B) and an anode BPP (60) acting as end plates.

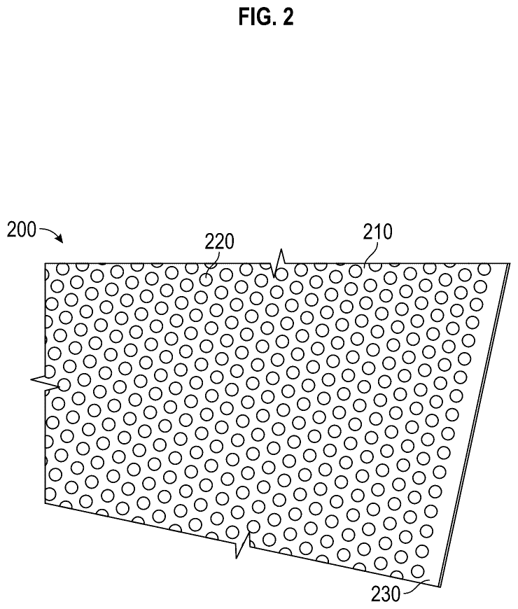

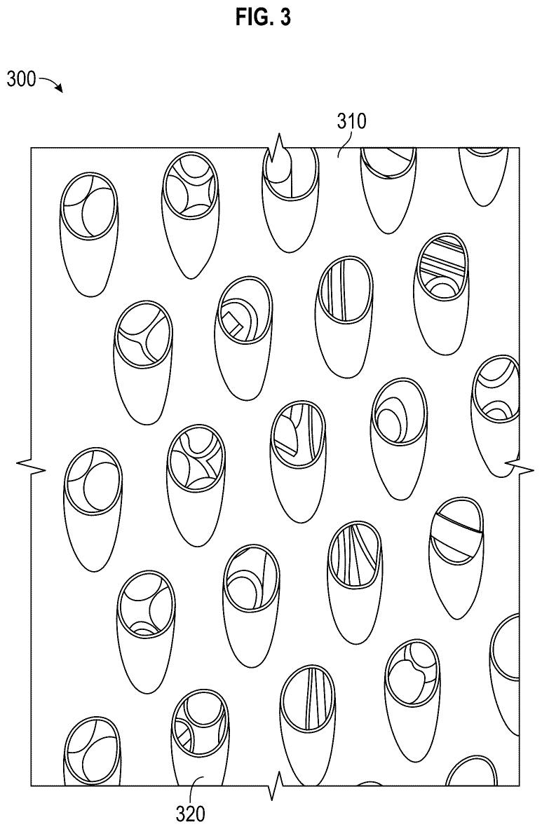

FIG. 2 illustrates a perforated mesh insert (200). The perforated mesh includes a flat sheet (210) with perforations (220) dispersed throughout the flat sheet (210). The perforations (220) may be dispersed uniformly throughout the flat sheet (210) and the flat sheet (210) can be corrugated to form peaks and valleys. The area of the flat sheet (210) which includes perforations (220) may include substantially all of the flat sheet (210). The flat sheet (210) may optionally have an edge portion (230) which does not have perforations (220).

FIG. 3 illustrates a scalloped perforated mesh insert (300). The scalloped perforated mesh (300) may have generally the same makeup and layout as the perforated mesh insert (200) expect of the nature of its perforations being scalloped. The scalloped perforated mesh (300) includes a flat sheet (310) with scalloped perforations (320) dispersed throughout the flat sheet (310). The scalloped perforations (320) may be dispersed uniformly throughout the flat sheet (310).

The scalloped perforations (320) allow for better capture and redirection of fluid flow to adjacent channels. These scalloped perforations (320) may point in varying directions. For example, successive scallops in a line may point first to the left by 30° of that line and then to the right by 30° in a repeating pattern. However, as depicted in FIG. 3, the scalloped perforations (320) may all point in the same direction.

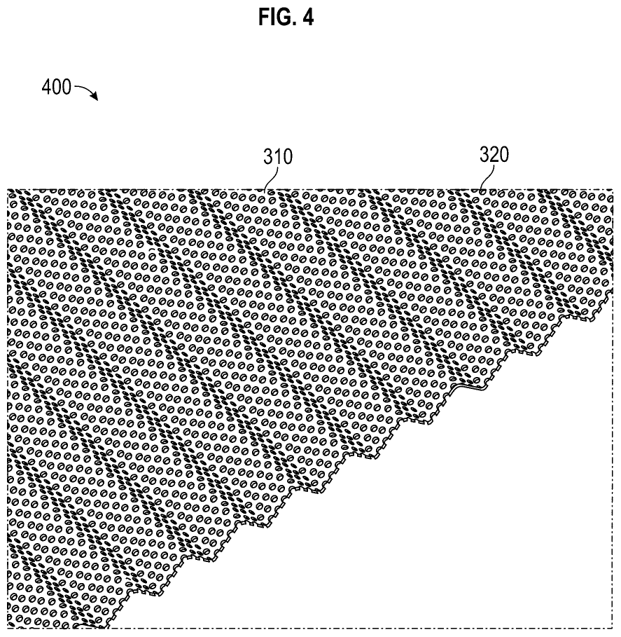

FIG. 4 illustrates a corrugated perforated mesh (400). The perforated mesh includes a corrugated sheet (410) with alternating ridges and grooves. The corrugated sheet (410) also includes perforations (420) dispersed throughout the corrugated sheet (410). The perforations (420) may be dispersed uniformly throughout the flat sheet (410) as depicted in the figure. The area of the corrugated sheet (410) which includes perforations (420) may include substantially all of the corrugated sheet (410).

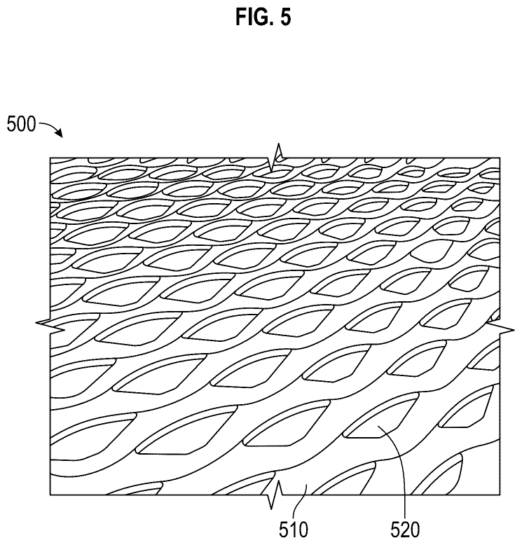

FIG. 5 illustrates an alternative mesh design example (500). The alternative mesh design includes the same basic structure as the other mesh designs described above including a sheet portion (510) and perforations (520). However, the perforations (520) have an irregular shape and pattern within the sheet. As depicted perforations (520) are dispersed uniformly throughout the sheet (510).

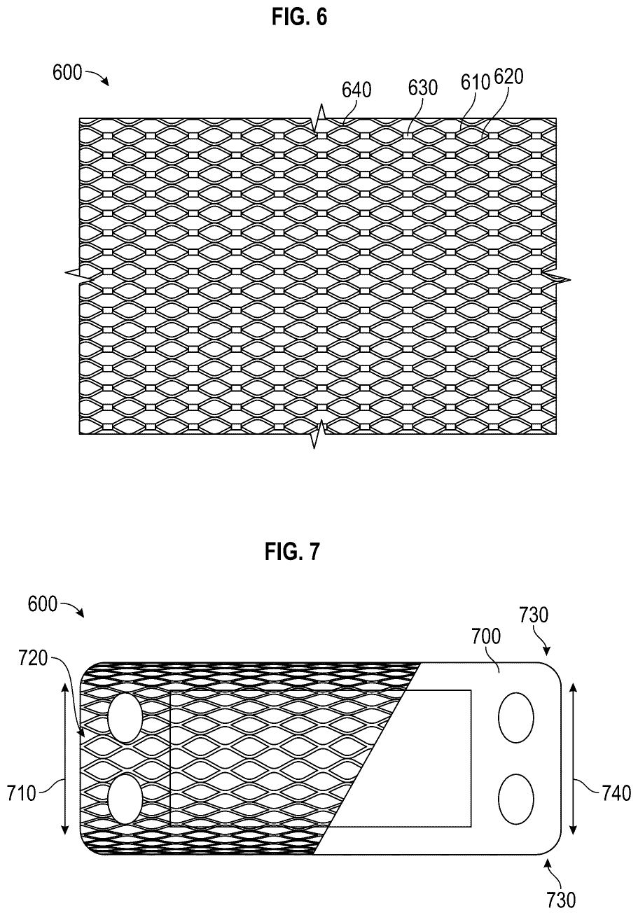

FIG. 6 illustrates a wire mesh insert (600). The wire mesh insert (600) includes rows of warp wires (610) and weft wires (620) joined to each other at a first intersection (630) which may optionally be reinforced by additional material or an additional reinforcement structure.

The first intersection (630) is depicted as reinforced in the figure. The row of warp wires (610) and weft wires (620) are also joined to the row of warp wires (610) and weft wires (620) above and below at a second intersection (640) by for example, brazing or welding. This joining may also be optionally be reinforced by additional material or structure.

As depicted the rows of warp wires (610) and weft wires (620) are aligned such that the intersections (630) and (640) are in vertical alignment with the intersections (630) and (640) of the other rows of warp wires (610) and weft wires (620) which make up the wire mesh insert (600) as a whole.

FIG. 7 illustrates an example of fluid and heat transfer across a wire mesh insert (600) in position on a MWA. MEA (700) includes a wire mesh (600) where the density of the mesh (710) increases from the middle portion (720) towards the edge portions (730) of the MEA (700). This coincides with the heat distribution across the MEA. As the coolant fluid travels from the middle portions (720) to edge portions (730), it heats up. However, the mesh density increases to match the heat gradient thus making the cooling more uniform across the MWA. That is, the wire mesh (600) is most dense in the hottest edge portions (730) of the MEA (700). The direction of fluid flow (740) is the same as the direction of increasing mesh density, flowing from the cooler portions (720) toward to the hotter portions (730) of the MEA (700).

In the embodiments including the various perforated structures described herein, the amount of perforations may increase moving from middle portions (720) toward to the edge portions (730) of the MEA (700). That is, having more perforations in the edge portions (730) of the MEA (700). This includes, for example, scallops, warp/weft wires, etc. This increased density of perforations corresponds to increased heat transfer area on the cell edges which can be optimized to match the heat gradient across the MEA (700) to maintain uniform cooling across the MEA (700).

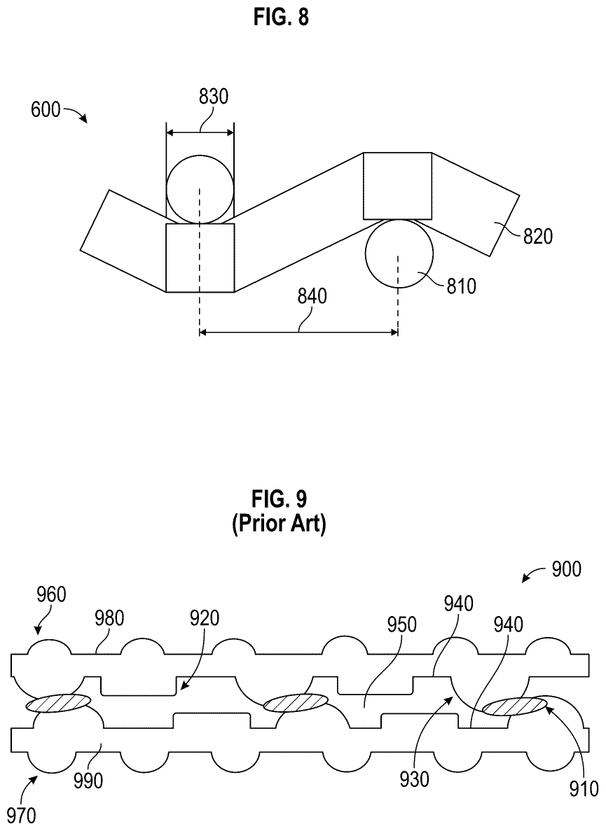

FIG. 8 illustrates an example of a warp/weft insert (600) having wire diameter (830) and wire pitch variation (840). As discussed above, the density of the insert (600) may be adjusted over the surface of the insert (600) from cooler to hotter areas of the MEA (700). This is achieved by varying the pitch (840) between the warp wires (810) and weft wires (820) where smaller pitch (840) results in higher density, increased strength and higher stiffness.

Increasing the wire diameter (830) will require the wire to travel a greater distance over the same wire pitch (840) to achieve the weave pattern depicted in FIG. 8 resulting in an increase in thickness of the insert. Varying the wire diameter (830) therefore can affect the thickness of the insert as a whole. In some embodiment, higher densities in load-bearing areas and in the best bonding surfaces for heat transfer can be selected.

The distance between the plates can be optimized to, for example, 1-10 mm, or from 3-5 mm, for example 4 mm by varying the wire diameter (830). The wire pitch (840) for fluid cooling features can also be optimized which in the context of PEM is, for example, 1-5 mm, for example, 2 mm, 3 mm, or 4 mm.

In some embodiments, such variation of wire pitch (840) is used to create patterns, for example, twill and multiplex. Another method would be through a customized stamping of features (i.e. mesh, scallops or perforated metal) with tuneable feature density (i.e. more or less perforations) enabled by a customized stamping tool with a convertible stamping head. For example, the strength, stiffness and cooling fluid turbulation characteristics of the insert are optimized by using a customized stamping tool instead of the brazed-together patchwork quilt to apply the previously described principles of smaller warp-weft pitch (840) and cooling fluid turbulating characteristics by higher feature density in regions of higher temperature (i.e. plate edges). This can be tuned by appropriately sizing the wire diameter (830) to control the thickness of the overall height between the bottom of a lower bend and the height of an upper bend-resulting in a strong, stiff reinforcing layer that would provide the optimal fluid gap between the two reactant plates for cooling. Additionally, the insert (600) can disrupt the thermal and velocity boundary layers of the incoming fluid resulting in much better heat removal from the system, following some similar principles as a heat radiator.

FIG. 9 illustrates examples of a comparative prior art stamped cooling channels on a BPP with the typical rectangular cooling features (920) forming cooling channels for coolant fluid flow. The cooling features (920) are positioned on an interior surfaces (940) of the insert (900) in the interior space (950) which functions as a cooling field. The cooling layer may be comprised of corrugated, stamped, folded or similarly formed aluminum plate or mesh. The stamped BPP may be coated in braising material (910) and/or joined together via, e.g. brazing together the plate bonding features. The plate bonding features (930) extend from the interior surfaces (940) of the insert (900) and are incorporated into the prior art stamped cooling channels. They can have a variety of shapes but are shown as rounded and shallow to illustrate a difference between them and the sharp rectangular cooling features (920). Additive manufacturing may be used as an alternative to brazing.

Anode flow field features (960) and cathode flow field features (970) are posited on the exterior surfaces (980 and 990) of the insert (900). These flow field features (960 and 970) allow for the flow of the relevant reactants. The anode flow field features (960) are positioned on the first exterior surface (980) which faces the anode and the cathode flow field features (970) are positioned on the second exterior surface (990) which faces the cathode. In FIG. 9, the BPP is stamped to have the cooling channels (920) on one side (which would be brazed) and the flow fields (960 and 970) provided on the opposite side contacting the MEA.

Materials used for manufacture may be aluminum, stainless steel, performant alloys, or other high-strength-to-weight materials, for example, titanium.

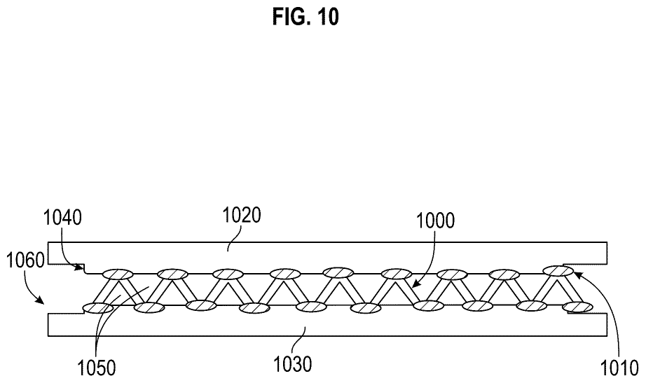

FIG. 10 illustrates an example of a corrugated insert (1000) positioned between the anode plate (1020) and the cathode plate (1030) and joined (1010) to the anode plate (1020) and the cathode plate (1030) at peaks and troughs via e.g. brazing or welding. FIG. 10 shows a cross section from the same direction as shown in FIG. 8 and relative to a fuel cell stack, is in the position of the circle from FIG. 1B. Such a corrugated insert (1000) may optionally be perforated to form the perforated corrugated insert e.g., (400). In some embodiments, each peak and trough of the corrugated mesh insert (1000) is joined (1010) to the anode plate (1010) or cathode plate (1020), for example, by brazing or welding. In some embodiments, all three layers, anode, insert, and cathode are all additively manufactured in one integrated process.

The insert may function as a cooling flow field separates the anode and cathode of different cells. The reactant flow fields of the anode plate (1020) and the cathode plate (1030) are on the side of the BPP contacting the MEA.

Materials used for manufacture may be aluminum, stainless steel, performant alloys, or other high-strength-to-weight materials, for example, titanium. The insert (1000) may be optimized to fulfill the function of maintaining compression pressure between cells. For example, by designing in a spring structure such that, once all cells have been compressed during stack assembly, optimal sealing pressure is maintained. The advantages of this embodiment include the reduction or elimination of the need for additional compression springs, saving weight and cost.

Indentation (1040) results from the positioning of the insert relative to end plate/anode/cathode. Cooling channels (1050) allow for coolant fluid flow. The cooling channels (1050) are formed by the structure of the insert (1000) in the space (1060) between the anode plate (1020) and the cathode plate (1030) and functions as a cooling field. The structure of the insert (1000) provides superior cooling capacity over the structure of the insert (900) in both cooling capacity, cooling distribution uniformity, and in the ability to optimize the specific cooling demands of a particular embodiment.

1. A proton exchange membrane fuel cell bipolar plate (PEM FC BPP) assembly comprising:
a cathode plate,
an anode plate, and
an insert, wherein the insert is positioned between the cathode plate, an anode plate; and
is comprised of a metal, a composite, a foil, a mesh, or a combination thereof, the insert comprising:
at least one corrugated structure having peaks provided from 1-10 mm apart,
wherein the at least one corrugated structure is bonded to the anode and cathode plates at, at least one of its peaks and troughs.

2. The PEM FC BPP assembly of claim 1, wherein the at least one corrugated structure comprises at least one perforation.

3. The PEM FC BPP assembly of claim 2, wherein the at least one perforation is a scallop-shaped structure.

4. The PEM FC BPP assembly of claim 2, wherein the density of the perforations is greater toward an edge portion of the at least one corrugated structure than in a middle portion of the at least one corrugated structure.

5. The PEM FC BPP assembly of claim 1, wherein the insert comprises plurality pieces which are brazed together in a patchwork quilt configuration, wherein at least one piece of the insert has a different geometry than the other pieces of the insert.

6. The PEM FC BPP assembly of claim 1, wherein the insert is bonded to the cathode plate and the anode plate by brazing with metals or alloys of Au, Zn, Ni, or Cu.

7. The PEM FC BPP assembly of claim 1, wherein the at least one corrugated structure is comprised of warp and weft wires.

8. The PEM FC BPP assembly of claim 7, wherein the pitch between warp and weft wires is varied to form twill or multiplex patterns.

9. The PEM FC BPP assembly of claim 7, wherein the density of the warp and weft wires is greater toward an edge portion of the at least one corrugated structure than in a middle portion of the at least one corrugated structure.

10. The PEM FC BPP assembly of claim 1, wherein the use of gaskets to maintain pressure between fuel cells is replaced or minimized by the insert under compression.

11. A method for cooling a proton exchange membrane fuel cell bipolar plate (PEM FC BPP) assembly comprising:
passing a cooling fluid though an insert positioned between a cathode plate and an anode plate of the proton exchange membrane fuel cell bipolar plate,
wherein the insert is positioned between the cathode plate, an anode plate; the insert comprising:
at least one corrugated structure having peaks provided from 1-10 mm apart,
wherein at least one corrugated structure is bonded to the anode and cathode plates at, at least one of its peaks and troughs.

12. The method of claim 11, wherein the at least one corrugated structure comprises at least one perforation.

13. The method of claim 12, wherein the at least one perforation is a scallop-shaped structure.

14. The method of claim 12, wherein the density of the perforations is greater toward an edge portion of the at least one corrugated structure than in a middle portion of the at least one corrugated structure.

15. The method of claim 11, wherein the insert comprises plurality pieces which are brazed together in a patchwork quilt configuration, wherein at least one piece of the insert has a different geometry than the other pieces of the insert.

16. The method assembly of claim 11, wherein the insert is bonded to the cathode plate and the anode plate by brazing with metals or alloys of Au, Zn, Ni, or Cu.

17. The method of claim 11, wherein the at least one corrugated structure comprises warp and weft wires.

18. The method of claim 17, wherein the pitch between warp and weft wires is varied to form twill or multiplex patterns.

19. The method of claim 17, wherein the density of the warp and weft wires is greater toward an edge portion of the at least one corrugated structure than in a middle portion of the at least one corrugated structure.

20. An electric device comprising an electric vertical take-off and landing (eVTOL) aircraft having the PEM FC BPP assembly of claim 1.
